(19) United States
(12) Patent Application Publication
(10) Pub. No.: US 2024/0009515 A1
(43) Pub. Date: Jan. 11, 2024

(54) Sport Motion Trainer

(71) Applicant: Watchit Group AB, Domsjö (SE)

(72) Inventor: Patric HÖRNSTEN NILSSON, Domsjö (SE)

(73) Assignee: Watchit Group AB, Domsjö (SE)

(21) Appl. No.: 18/473,050

(22) Filed: Sep. 22, 2023

Related U.S. Application Data
(63) Continuation-in-part of application No. PCT/IB2022/052800, filed on Mar. 28, 2022.
(60) Provisional application No. 63/166,989, filed on Mar. 27, 2021.

(51) Int. Cl. A63B 24/00; A63B 71/06

(52) U.S. Cl. CPC A63B 24/0006; A63B 71/0622; A63B 2102/32

(57) ABSTRACT

A sports training arrangement, especially but not exclusively suited for golf, includes a body-worn unit that includes acceleration sensors, and a portable unit such as a smart phone that receives acceleration signals from the body-worn unit. The path of the sensing unit is computed and compared with an intended target path and the player is signaled in real time to indicate conformance of actual motion to the intended target path.

### CROSS-REFERENCE TO RELATED APPLICATIONS

This application is a bypass continuation-in-part of International Patent Application No. PCT/IB2022/052800, filed 28 Mar. 2022, which in turned claimed priority of U.S. Provisional Patent Application No. 63/166,989 filed 27 Mar. 2021. This application claims priority of both of these prior patent applications.

### TECHNICAL FIELD

This invention relates to training systems for sports.

### BACKGROUND ART

The ability to consistently follow certain patterns of motion is essential to success in many sports. The javelin or discus thrower, the cricket bowler and ten-pin bowler, the speed skater and cross-country skier, the archer, and many other participants in sports, all strive to improve their results by improving their ability to execute certain motions precisely and repeatably.

There are, accordingly, countless products available to professionals and amateurs alike to help them analyze their motions and help them improve their performance. Many of these systems involve some arrangement for capturing data relating to motion of some part of the player's body and then presenting this for later analysis and critique.

Other arrangements mount sensors on the equipment used. These have the obvious disadvantages of not only requiring the sensors to be able to withstand the forces that arise during the activity, but also, in some cases, of changing the mass properties of the equipment itself; such fixtures on the equipment may also be a distraction.

Still other existing systems require the player to wear equipment such as specialized vests, harnesses, or the like that on which several sensors are mounted. The most obvious disadvantage of these products is that the player must buy them separately at all. Another disadvantage is that these extra items of kit are not what the player normally has on him as he plays and this may create a distraction that affects the player's ability to concentrate.

Common to all such systems is that they are intended solely for post-activity analysis—they have no ability to guide the player during a motion, in real time. Identifying points for improvement after the fact is valuable, of course, but does not truly help the participant get the proper feel of correct motion, which makes it harder to develop the correct muscle memory.

Some known systems for training players of for example golf and American baseball attempt to achieve “almost” or at best “slow motion” “pseudo-real time” feedback to the players. In these systems, a system such as a laptop computer is positioned in front of the player. Using either image capture techniques from the laptop's camera, or by receiving via an antenna arrangement sensor data transmitted by devices mounted on the player or his equipment, the system then displays performance information that either the player or a coach can view to guide the player to perform correct motions. In some cases, the system displays differently colored dots to indicate whether the player is following a correct path or not, and in other cases the system guides the player with tones or even music. As in other systems, these products assume that the player must have the separate system—the laptop—available, which can be cumbersome at best and impractical in inclement weather. Even so, a player in a sport such as golf will not be able to concentrate on his stroke while looking for an indication on a display screen, even if this is done in slow motion, and even if guidance is audible, the presence of a system such as a laptop and antenna in the player's immediate field of view can be a distraction in and of itself.

### BRIEF DESCRIPTION OF DRAWINGS

FIGS. 1A-1D illustrate various phases of a golf swing viewed from the side.

FIGS. 2A-2D illustrate various phases of a golf swing viewed from the front.

FIG. 3 illustrates a swing path from setup, to top of swing, to impact, and to end of follow-through.

FIG. 4 depicts a golfer who is using a sensor/transmitter unit and main unit.

FIG. 5 illustrates software and hardware components of the invention, some of which are optional and/or can be reconfigured.

FIG. 6 illustrates both a measured swing path and a correct swing path.

FIGS. 7A and 7B depict an arrangement for imaging a player and extracting stroke information.

FIG. 8 illustrates a multi-sensor embodiment used to provide guidance with respect to relative motion.

### DESCRIPTION OF EMBODIMENTS

As will be clear from the description below, this invention may be used as a training tool for participants in a wide range of sports in which the participants may want to learn, or improve their ability, to consistently execute certain motions precisely. Perhaps more than any other major sport, golf is a game that requires such consistency and precision at a fine level. For example, a change of only a couple degrees in the angle of attack of the club face relative to the ball can mean the difference between the ball landing on the green or disappearing into a water hazard. Similarly, consistency in the club path, stroke speed, and timing from when the player first sets up on the ball until completed follow-through is essential to being able to achieve the desired range, azimuth, and sometimes even spin. For these reasons, embodiments of the invention are described below primarily with reference to the game of golf, but this is by way of example only. Modifications to the procedures and components described below to accommodate the expected needs of players of others sports are either mentioned explicitly, or will be within the skill of those who design software that processes sensor data.

For purposes of analysis and instruction, a golf swing is typically viewed as comprising several phases. One common scheme breaks a swing down into the phases Setup & Address, Takeaway, Backswing, Top of the Swing, Downswing, Impact, Release, and Follow-Through. These are well known, but are also described briefly below as background for understanding various features of different embodiments of the invention.

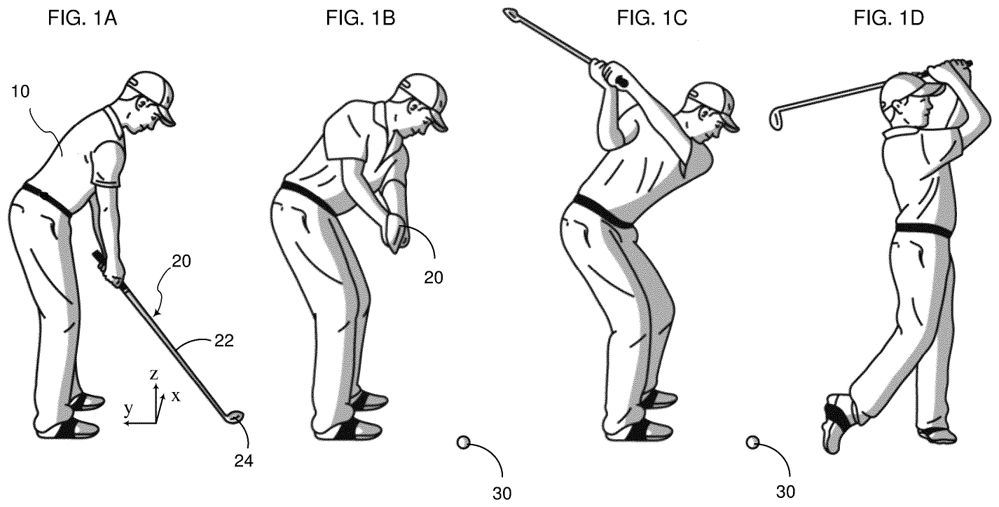

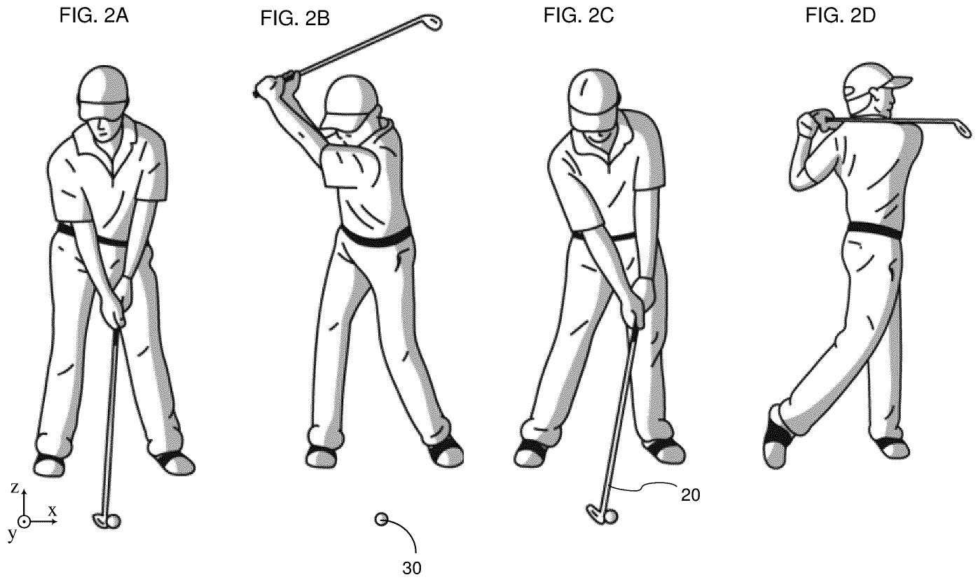

For illustrative reference only, an x-y-z coordinate system is shown in FIGS. 1A and 2A, with the x-axis being horizontal, pointing generally in the direction of the line on which the players' feet are aligned; the y-axis, also horizontal, perpendicular to the x-axis, that is, towards and away from the player; and the z-axis vertical and perpendicular to the other two axes. Of course, any other coordinate system, Cartesian or otherwise, may be used not only as a reference system for position and motion, but also in the computations described below.

Setup and Address (FIG. 1A and FIG. 2A): The player 10 positions his body and club 20 and prepares for the stroke. Generally, at address, the ball 30 will be in front of the player, roughly in the middle between his feet when using a short iron and progressively towards the front foot as the length of the club increases. The ball will be located away the body in such a way as to allow the sole of the clubhead to lie flat on the ground during setup. As such, the ball will be closer to the player when using a short club and will move progressively farther away when longer clubs are used. Typically, depending on the player's chosen grip, the hands will be located ahead of the ball (in direction of intended travel) at setup and address.

Takeaway (FIG. 1B): This phase of a stroke typically encompasses the motion from setup to when the club is approximately parallel to the ground.

Backswing: This phase is the continuation of the “wind up” of the stroke, in which the club head 24 travels further away from the ball and upward.

Top of the Swing (FIG. 1C and FIG. 2B): As its name implies, this is the point at which the direction of motion of the club head will change and begin to travel back towards the ball. In general, it will be the point of least velocity after the start of the takeaway and will be at or close to the point at which the x and z components of both velocity and acceleration of the club head change sign.

Downswing: Also as its name implies, this is the phase of the stroke in which the club head travels from the top of the swing towards the ball.

Impact (FIG. 2C): At this point, the club head strikes the ball. Note (compare FIG. 2C with FIG. 2A) that, typically, the player's hands will often, and preferably, be somewhat farther ahead of the ball than during address.

Release and Follow-Through (FIG. 1D and FIG. 2D): After the ball has been struck, the player continues to swing the club until the end of the stroke, at which point the hands are near the shoulder facing the direction of travel of the ball. Compare FIG. 2B with FIG. 2D: For a proper, powerful stroke, the player's hips will generally rotate, and weight will be shifted onto the leading foot.

Note that all these shot phases are typical when the player is using an iron or wood, whereas some may not be present in other types of shots. When using a putter or wedge, for example, the “takeaway” and “backswing” may be considered to be “merged” into a single, shorter phase, and the “top” of swing and “follow through” phases will also not extend as far from the setup position as when the player is, for example, hitting a driver. The procedures described below do not depend on any particular length or “decomposition” of a swing path; even for short motions such as a putt, there will still be a swing path that can be sensed. Moreover, the trajectory and number of proper phases of motion may be different in different sports.

During a stroke, not only will the club head define a path in three-dimensional space, but so will any point on the player's hand or wrist. Moreover, if the geometry of the chosen club is known, in particular, its length, and the player uses any standard grip, then it is possible using known geometric and algebraic computations to fairly accurately estimate the position and thus the path—the swing path—and velocity of the club head if the path and velocity of, for example, the user's wrist are known.

Given the components (functions, since they will vary during the course of a shot) of linear acceleration in orthogonal directions, the system, for example, the component 231, may apply standard transformations to determine components of angular acceleration of the sensing unit as well. These may similarly be integrated to obtain components of angular velocity. Given the known angular velocity at the point of the sensing unit and the length of the club, and assuming the player does not break his grip during a stroke, the system may also compute a value of club head velocity/speed, in particular upon impact with the ball: As is well known, the speed of a point located at length l from a coordinate origin where the angular velocity is w is simply ω×l. Given the speed of the sensing unit at the moment of ball impact and the angular velocity, an estimate of the length of the sensing unit from the theoretical origin can be computed, and the length of the club shaft from the grip to the club head can then be added to that length to obtain an estimate of the distance from the origin to the club head, which, multiplied by the sensed and computed angular velocity, will provide an estimate of club head speed.

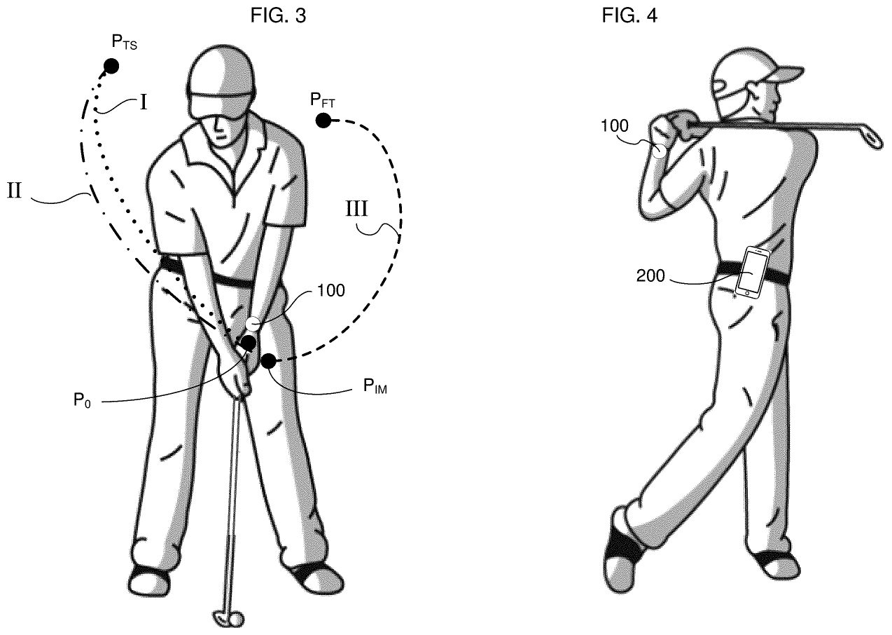

See FIG. 3, which illustrates three partial paths that the player's left hand might take during a stroke. (The player is show here as being right-handed by way of example only; a “mirror image” of the figures would show the paths for a left-handed player.) Thus path I (dotted arc), from the initial setup point P₀ to the top of the swing P_{TS}; path II (dash-dotted arc) from P_{TS} to the position P_{IM} of impact; and path III (dashed arc) from P_{IM} to the position P_{FT} at the end of the follow-through.

An important factor in hitting a powerful, accurate shot is for the player to consistently execute a stroke with an optimal swing path. Much research has been devoted to studying the swing paths of the top players, which are often similar. Many of the training products on the market today have as a goal to analyze the swing paths of players, after the fact, with the goal of helping them learn to follow more optimal paths from the viewpoints of consistency, power, accuracy, etc.

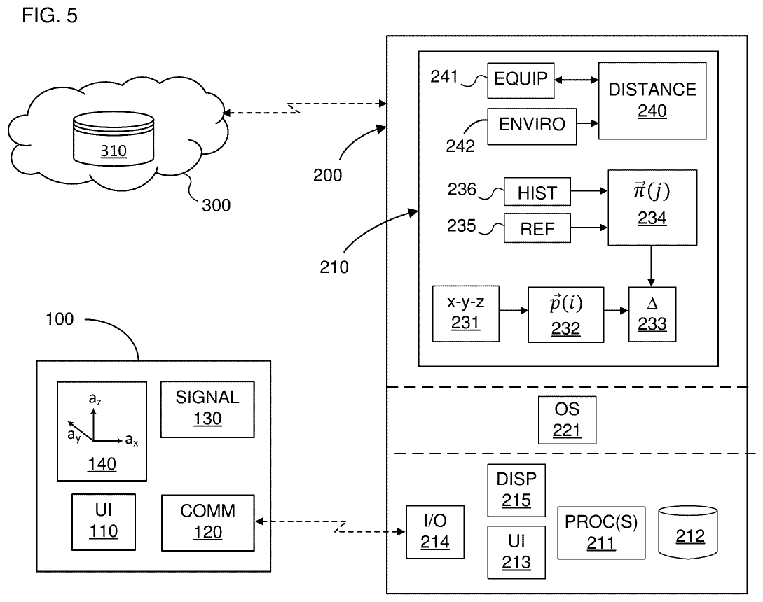

In FIG. 4, the player is shown with two units: a sensing unit 100, such as a “smart watch”, “sports watch”, activity tracker, or other wireless-enabled wearable technology device, and a portable unit/device 200, such as a “smart phone” that can easily be carried on the player's person, such as in a pocket, attached to a belt, etc., and that he may well normally be carrying with him while playing anyway. Assuming sufficient storage size, communications ability, processing power, input/output ability, and comfort, it would also be possible to combine both units 100, 200 into the single sensing unit; many modern “smart” and “sports” watches have sufficient processing capability to carry out the functions described here. They are shown as separate devices here because it is anticipated to be the configuration likely to be preferred by most players, and also because it allows for use of commercially available units 100 such as a “smart watch” with minimal or no software modification or installation. As smart watch (or similar) technology evolves, however, this may not be a constraint. Although it will in most cases be more natural and less obtrusive for the sensing unit 100 to be worn on a golfer's wrist, and will also provide the greatest precision, this is not necessary, and the sensing unit 100 could instead be worn, for example, on the hand, such as being incorporated into the back side of a glove, although the size and weight should be small enough as to not cause a distraction or cause the player to change his natural stroke. As mentioned below, in other sports, and depending on which motion/s is/are to be tracked, the sensing unit 100 may be worn or carried somewhere else on the body, such as the ankle, on a shoe, boot or skate, on the elbow, etc. Note that this invention makes possible real-time guidance to the player using non-specialized hardware devices such as a smart or sports watch and a smart phone.

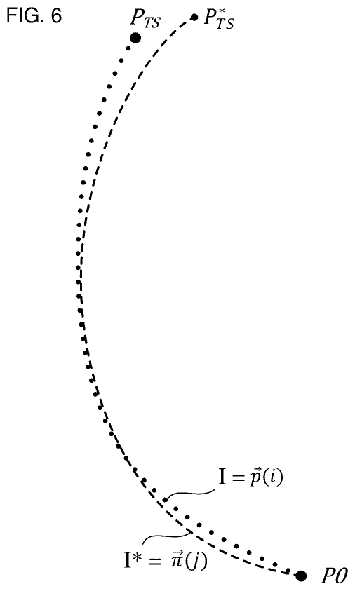

FIG. 5 shows some of the hardware and software components of the units 100, 200. Note that although several components—in particular, software components and routines—are shown as being separate, in many cases this is primarily for purposes of clearer explanation, and some or all of them may be combined into a single body of executable code.

The sensing unit 100 may include a user interface 110 that allows the user at least to activate the calibration and measurement routines described below, unless this is done via the device 200 instead. This could be as simple as a physical button or a touch-screen icon, or by voice command if the sensing unit 100 has such capability. Alternatively, the sensing unit's functions with respect to this invention may instead be controlled totally via the portable unit 200, with no need for the user to manually set anything on the sensing unit itself. The sensing unit 100 includes a wireless communications component 120, which may communicate with a corresponding I/O component 214 in the portable unit 200 using any known technology, such as Bluetooth, NFC, etc.

The sensing unit 100 preferably includes a signaling device 130, which is either audible, or haptic, or both, and/or even a voice signal; in other embodiments, the signaling device may instead be included in the portable unit 200. If the signaling device is included in the sensing unit, then it generates the audible and/or haptic signal upon receiving a signal to do so from the portable unit. This signaling device may be, for example, the same as is commonly used by such a unit's clock alarm, countdown timer, etc., to generate a “beep” or other tone. Similarly, such units frequently include such haptic signaling devices as a vibrator, and most also include a capability to play predetermined voice “signals”, which may be considered a special case of audible signals. Both audible and haptic signals may typically be initiated by way of the system software included in these types of units.

The sensing unit 100 also includes a 3-axis inertial sensing unit 140, such as a set of MEMS (Micro-Electro-Mechanical Systems) linear accelerometers or MEMS “gyroscopes” (that is, more correctly, angular rate sensors), which generate signals that either correspond to, or, using known mathematical operations, can be converted into acceleration values in three orthogonal directions, usually in a reference frame fixed with respect to the casing of the sensing unit 100. Using known coordinate transformation algorithms, these may be converted into acceleration values aₓ, a_{y}, a_{z} in the reference frame of the player, such as x-y-z or the like. Such sensors are already commonly found in devices such as “smart watches”, activity trackers, and the like. If the device itself does not correct out gravity acceleration, then this may also be done using known techniques.

As one learns in every introductory Physics class, if, in a Cartesian x-y-z coordinate system, at time t0=0, an object has an initial position \vec{p}(0)=(pₓ(0), p_{y}(0), p_{z}(0)), and an initial velocity \vec{v}(0)=(vₓ(0), v_{y}(0), v_{z}(0)), then the position \vec{p}(t)=(pₓ(t), p_{y}(t), p_{z}(t)) of the object at time t that has acceleration \vec{d}(t) may be computed from the formulas:

\vec{p}(t)=p(0)+∂₀^{t}\vec{v}(t′)dt′, (EQ 1)

\vec{v}(t)=\vec{v}(0)+∂₀^{t}\vec{a}(t′)dt′, (EQ2)

where \vec{v}(t′) is the velocity vector at time t=t′, and \vec{a}(t)=(aₓ(t), a_{y}(t), a_{z}(t) are the instantaneous x-y-z components of acceleration.

The discrete forms of EQ1 and EQ2 are also well-known and are used when, such as in this invention, acceleration values are available only at discrete intervals. This is the case, for example, when the essentially continuous physical output signals generated by inertial sensors are sampled. In the discrete case, the position \vec{p}=\vec{p}(i)=(pₓ(i), p_{y}(i), p_{z}(i)) at discrete times i, for i=0, n, where i=0 is the initial value and n corresponds to the final sampled value in the sequence.

Note, that the components of acceleration along a swing path for any point associated with the swinging of a golf club will in general not be constant. In the context of this invention, the relevance of this is that, given the aₓ, a_{y}, a_{z} values obtained from or derived from the inertial sensing unit 140, known mathematical techniques may be used to compute, for any time t, the position \vec{p} in the x-y-z-coordinate system of the sensing unit 100. A coordinate computation component 231 is, accordingly, included in the portable unit 200 to compute \vec{p}(i), that is, the x-y-z position of the sensing unit 100, for each acceleration vector sensed by the module 140, whose component values aₓ, a_{y}, a_{z} the sensing unit 100 may transmit to the portable unit 200 over the chosen communication channel.

If position values are computed using acceleration values obtained at a sufficient sampling rate, which almost all “smart watch” and activity trackers can easily achieve, then the path of the unit 140 from an initial rest position \vec{p}(0) may be defined as the sequence of values \vec{p}(i)=(pₓ(i), p_{y}(i), p_{z}(i)) at discrete times i, for i=0, n, where i=0 is the time of the start of a swing path, that is, at setup and address, and n corresponds to the last measured acceleration vector.

For many players, the goal is to have either a one-plane, or two-plane swing path, that is, there is an assumption that the swing path should lie in one or two planes. Any such assumption is of course just a simplification of representing a swing path in the more general case of 3D space; besides, one problem even such players have is that they do not swing in a plane, and thus their movements need to be detected in all three dimensions. Nonetheless, if only a 2D analysis is required in a particular implementation of the invention, the formulas described here may be adjusted using known methods, for example, by simple projection onto the assumed plane of the swing path.

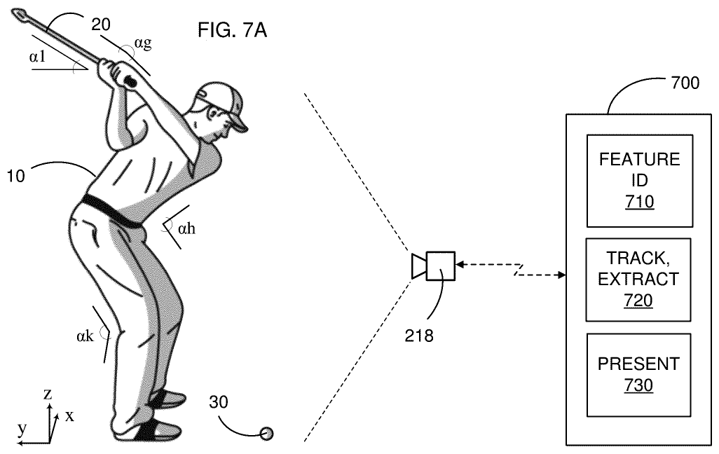

FIG. 6 illustrates phase I=\vec{p}(i) of a sensed swing path (for the sensing unit 100), as well as a proper, correct, desired swing path I*, which may also be defined (and stored) as a sequence of vectors π(j)=(πₓ(j), π_{y}(j), π_{z}(j)), j=0, . . . , m in 3D space relative to the setup point P₀. Here, “proper” or “correct” means that the swing path is generally accepted by skilled players as being optimal in terms of such characteristics as repeatability, power generation, club orientation upon impact, etc. In FIG. 6, I is shown as a dotted arc and I* is shown as a dashed arc. The goal is to help the player learn how to swing the club with the proper path, which, given a proper grip, is substantially the same as saying he should learn to move his wrist, and thus the sensing unit 100, so as to follow I*.

Different methods may be used to establish I*, either “standardized” or “customized” or both. For most players of a given height, torso length, arm length, etc., an ideal swing path is known from existing studies and may be discretized to obtain the sequence of values (πₓ(j), π_{y}(j), π_{z}(j)) for storage. A storage component 235 is illustrated in FIG. 5 for such “reference” values.

The proper path values may also be compiled for each individual player (or for professionals who serve as a reference). For example, during a training and calibration session, a player may execute a number swings, on a course or in a simulator, whose coordinates are recorded, while a trainer observes. The values for correct swings may then be compiled and, for example, averaged, to generate a correct, personalized swing path for the player. Data capture could be done using existing simulator technology, or by using this invention in a “learning” mode. Another method for capturing data defining a correct swing path would be to use one or more cameras to image, for example, an optic marker on the wrist of a highly skilled player as she executes a correct stroke, and then to use known techniques to capture the coordinates of points of the path. A storage component 236 is illustrated in FIG. 5 for such “historical” reference values. Such historical path values, both “good” and “bad”, could also be stored if desired for later display and analysis.

Note that the concept of “path” may optionally also include velocity values \vec{v}(i), which may be obtained (using a single integration operation) from the same acceleration values as are used to determine instantaneous position (which involves two integration steps). Along with compiling and measuring both “correct” and “measured” position values, the system may also compile and measure both intended, “correct” and actual, “measured” velocity profiles \vec{V}(i), \vec{v}(i), respectively, which may be obtained (using a single integration operation) from the same sensed acceleration values, using the same techniques. If included, this feature will allow the system to detect not only spatial path deviation, but also deviation from a correct velocity profile. Any known metric (L1 norm, L2 norm, etc.) may then be used to quantify the degree of deviation between the two velocity profiles. To simplify computations, with no meaningful loss of useful information, the system may instead use a speed profile comparison, that is, comparison of a measured one-dimensional profile |\vec{v}(t)| with a correct speed profile.

This may be extended even further by compiling and storing both actual and correct acceleration profiles for a swing path; acceleration values are, after all, the “raw” information provided by most inertial sensors such as sensor 231. If the chosen sensors also themselves output velocity information as well as, or in addition to, acceleration information, then the velocity information may be used directly, with no need for integration within the device 200 to obtain velocity values. Even without storing a “correct” acceleration profile, the system, based only on the measured acceleration profile (which may also be based on one-dimensional magnitude values instead of vectors), may apply any known metric to determine the “smoothness” of the actually measured acceleration profile so as to be able to detect any “jerkiness” in the player's swing.

Now assume that a player wishes to start a stroke. The player may then start the application (depicted as 210 in FIG. 5) on his portable unit 200 and assume the setup and address stance. The system must first establish the initial rest position P₀, which may then serve as the origin of the coordinate system used as the reference frame in acceleration measurements. The portable unit, for example, the component 231, may then issue any necessary commands to the sensing unit 100 and begin to input acceleration values. That the sensing unit 100 is at rest at a position P₀ means, in practical implementations, either that |\vec{a}(t)|≤ϵₐ for some predetermined period, where ϵₐ is a predetermined acceleration threshold, and/or that |\vec{v}(t)|≤ϵᵥ for some predetermined period, where ϵᵥ is a predetermined velocity threshold. The system may therefore automatically sense the beginning of the takeaway phase, which may be defined as the time at which either |\vec{a}(t)|>ϵₐ or |\vec{v}(t)|>ϵᵥ either at all, or after having been so for more than a predetermined threshold period.

An additional or alternate metric of “rest” may also be computed based on position values. For example, the mean of a sequence of k position values \vec{p}(k) may be computed, for example, as a moving average, and the system may consider P₀ to be established when, for example, no position value has been detected more than a maximum threshold distance from the mean over some predetermined period, or the standard deviation or least-squares value of the distances of position values from the mean is less than a predetermined threshold value, etc. In FIG. 3, the initial point P₀ appears slightly offset from the position of the sensing unit 100. This is only to make it easier to visualize; in practice, P₀ will also be the position of the sensing unit at that time.

Once the initial position P₀ has been determined, either the sensing unit 100 or the portable unit 200 may then signal the player, either audibly and/or haptically or otherwise, that he may begin his swing. The system then also continues to capture acceleration data and compute position points \vec{p}(i) at whatever sampling rate has been implemented. During the swing (as illustrated, the takeaway and backswing portions), the system may then compare the actual path \vec{p}(i) (and, optionally, velocity profile and/or acceleration profile) with the correct path \vec{π}(j) (and, optionally, correct velocity and/or acceleration profile) and signal the player if these paths differ from each other by more than a predetermined threshold metric. It would also be possible to determine the correct path \vec{π} as a function of time, that is, \vec{π}=\vec{π}(j, t), if the players stroke is to be evaluated not only with respect to path in space, but also velocity or speed at each part of the swing. Note that a “path” can be considered to be a set of intended positional points.

Any known metric may be used to determine unacceptable path deviation, that is, the “delta” A between the correct position and the actual position. In FIG. 5, a component 234 is shown as being included to compute this metric, indicating a degree of closeness of correspondence between the actual, sensed path and the intended, “correct” path. For each measured point (or some sub-set thereof, such as every n′th), a Euclidean distance may, for example, be computed between the actual position and the closest point of the correct path I*. Alternatively, the Euclidian distance between the actual position and an optimal position at the same time, where \vec{π}=\vec{π}(j, t) could be computed. The portable unit 200 (for example, the component 234) may then cause either the portable unit 200 itself, or the sensing unit 100, to generate a signal whenever this distance, or a statistic of this distance (such as mean, root mean square, standard deviation, etc.) exceeds a threshold value, or exceeds it for at least some minimum number of sampling periods. Alternatively, the system may generate a signal, such as a tone or haptic vibration, as long as the player's swing path's deviation is less than the deviation threshold such that the player will want to keep the tone or vibration during the swing.

As mentioned above, if the system is configured to track velocity and/or acceleration profile deviation as well, then the system may use either the same signal as for position deviation, or may generate different signals for the different types of deviation. Since velocity is by definition equal to a change of position divided time, note that instead of or in addition to a “velocity profile”, the system could make \vec{π} itself a function of time, that is, \vec{π}=\vec{π}(j, t). In other words, a player could be guided not only with respect to a path in space, but also with respect to the timing of a swing. The deviation of the sensed position at each (or each k′th) sampling time measured from the start of the swing could thus be computed with respect to the “goal” position at that time.

Of particular interest in developing a proper swing, especially for the sake of consistency and predictable distance, is the point P_{TS}, that is, the top of the swing. In this example, P_{TS} is an “intended” position, that is, a point the player should intend to reach in his swing before beginning the downswing. The portable unit 200 therefore may either generate, or cause the sensing unit 100 to generate, an audible and/or haptic signal when the player's position has reached the proper P_{TS} point, which will also signal to the player that it is from this point that he should begin the downswing. “Reaching” the proper point P_{TS} preferably is defined to mean that the distance between the actual position of the sensing unit 100 and the pre-determined position P_{TS} is less than a pre-determined threshold value; in short, the position of the top of the swing is close enough to P_{TS} as to require no adjustment on future strokes. In some implementations, it will be sufficient to signal that the player's backswing has reached the proper height, that is, the proper z-component of P_{TS}, regardless of the other two coordinates.

Certain other deviations from a correct swing path are often caused not by a fault in the player's arm motion as such, but because of other mistakes in body mechanics, such as errors in load and release patterns. For example, if the sensed initial motion of the sensing unit (100) is horizontal, that is, substantially parallel to the ground (x-y) plane (that is, with a z-direction acceleration component less than a predetermined threshold value), over greater than a predetermined threshold distance (absolute or relative to the player's input height), then this will tend to indicate an improper over-shifting of the player's body, in particular onto the rear foot. Similarly, a vertical motion (for example, exhibiting a z-direction acceleration component greater in magnitude than that of the x-direction acceleration component) at the beginning of the stroke greater than another predetermined threshold distance (also absolute or relative to the player's input height) will tend to indicate, for example, over-straightening of the knees and/or hips. If the portable device 200, based on acceleration signals input from the sensing unit 100, detects either of these situations, then the portable device may communicate to the sensing unit that it should generate a corresponding audible and/or haptic signal, or the portable unit could generate the signal itself.

In some implementations, the process of tracking the actual swing path and comparing it with a correct swing path may be carried out even during the downswing, impact, release, and follow-through phases of a swing. In general, however, these phases may occur too fast for the player to benefit from signaling of deviation, at least during a normal swing. The data may, however, still be collected for later analysis; moreover, in other sports the path after a “wind-up” or other preparatory motions may occur slowly enough that providing audible and/or haptic guidance may be feasible and useful. Note, however, that if deviation from a velocity and/or acceleration profile is not of interest, then the player may not necessarily be guided with respect to the timing of a swing, but rather may swing as slowly as the player desires. In this case, tracking and signaling path deviation all the way to the point of impact or beyond may be useful, and may be done using the same method as just described for phase I of the swing. Such “slow motion” tracking may give the player a better chance to get the “feel” of a proper swing, of proper hip rotation and weight transfer, etc. If desired, the portable unit 200 may therefore be configured to input (using any conventional input device or facility, such as a touch screen) and implement the player's selection of different tracking modes, such as “backswing only”, “full swing”, “top of swing indication only”, etc.

All other things being equal, in particular, the swing path and velocity profile, the distance a ball will travel will depend primarily on the length of the club shaft 22 and the loft angle of the club head 24. Thus, assuming a consistent stroke, a player may generally assume that the ball will travel farther or less far depending on which club he selects for the shot. This means further that, for a given player, it is possible to compile and store a database that indicates, for a given club, what distance the player should expect to hit the ball, assuming the proper swing path and velocity profile, with possible adjustments for other factors.

In FIG. 5, the portable unit 200 is shown as having an optional distance component 240, which also represents the portion of the storage/memory component 212 that may be used to store club-to-distance values in a database or table. Each club in a matched set is designed to propel the ball a known distance compared to the other clubs in the set. The actual distances achieved, however, will vary from player to player, manufacturer to manufacturer, model to model, and ball to ball.

One way to compile such a database is to input the actual results of multiple shots by the player using different ones of his clubs. The achieved distances may then be compiled, input, and, for example, averaged, to form the basis of club-to-distance relationship values for the player. This could be built up over time and therefore better customized. For example, during actual play, the user could input distances achieved using different clubs, optionally also inputting the environmental conditions at each time. Instead of, or in addition to inputting results of play on an actual course, the distance routine could also be “trained” (its database built up) using values obtained from simulated play in any of the many known training simulators or “virtual courses”. In embodiments that include this distance-estimating feature, the user may be given the option, for example via a routine 241, to input her club choice. The distance component may then indicate the expected carry distance.

It would also be possible simply to use known loft-distance tables, many of which are free or commercially available. These are available for different categories of players, such as according to age, height, sex, ability, etc., and may be used in the distance component 240 instead of, or in addition to, personalized club-distance data.

As FIG. 5 illustrates, in some embodiments the portable unit 200 does not itself store data such as loft/distance tables, optimal swing paths, equipment parameters, and possibly even player history, or at least maybe not all of these, but rather may retrieve this data as needed, using known communication methods, from a remote system 300, which may include storage 310 used for this purpose.

In FIG. 5, the signal path between the distance component 240 and the routine/data set 241 is shown as being two-way. This is to indicate that the distance unit could optionally be configured to recommend (via a display 215, for example) to the player which club to use based on inputting from the player a desired distance.

The nature (such as manufacturer and model) of the ball may also affect carry distance and may optionally also be included, possibly as an input from the user, to be applied via the equipment-related routine 241, as a factor in the distance component 240.

As a further optional feature, the user may be given the option to input, via a routine 242, environmental factors such as wind speed and direction. To accomplish this, the display 215 of the portable unit 200 could allow the user to input “raw” information such as wind speed and direction (preferably relative to the desired ball trajectory, such as “180 against”, “90 degrees from right”, 30 degrees from left, with”, etc.), or it could display a compass-like, graphic representation of angle, such as “ball trajectory up” and allow the user to touch the screen at the position of relative wind angle and then either enter an estimated speed numerically, or graphically, for example by sliding an icon, expanding a ring, etc. The distance component 240 may then adjust expected distances either by calculation from existing formulas that are functions of at least air resistance, or by applying known corrections (which it may include in its internal database), or using any other known method.

Other environmental factors may optionally also be applied to adjust expected distance. For example, a user may be enabled to input such factors as grass type, wetness, air temperature, course altitude, etc., any or all of which may affect the carry of the ball in known ways and may also be stored, for example, as a table or using approximating functions.

Portable units 200 such as smart phones are essentially special-purpose (telephony) computing systems. As such, the portable unit 200 will include standard components such as system hardware with at least one processor 211, volatile and/or non-volatile memory and/or storage, indicated “collectively” as component 212, and standard I/O access components 214 to enable communication with other entities and systems over any known type of network, such as by Bluetooth, NFC, with the sensing unit 100. Some form of user interface 213 is also included to allow user to control the settings and general operation of the system; the UI 213 may include, or be separate from a display 215, which may be configured, for example, as a touch screen. The processor-executable code organized as software modules used to carry out the various computations and functions described above may be stored and thus embodied in either or both types of memory/storage components 212. The software modules will thus comprise processor-executable code that, when run by the processor(s) 211, cause the processor(s) to carry out the corresponding functions. Some form of system software will also be included, such as an operating system 221.

The portable unit 200 will also include an application layer, which comprises various software components/modules for performing the functions described above. In particular, the various software components used described above may be included in an “application” 210, which may be loaded into the device 200 in any conventional manner. As mentioned above, the various software components need not be separate modules, but rather some or even all of these may be combined into single bodies of executable code.

Data such as those relating to swing paths (235, 236), parameters such as equipment characteristics and environmental factors (241, 242), distance tables, 240, etc., will be stored in respective portions of the storage/memory system 212 and may be either pre-installed, or be downloadable (for easy updating), or both. In an interactive embodiment, it would also be possible either for the player, or a coach, to select and change the desired swing path I* (and thus the set of vectors \vec{π}(j)=(πₓ(j), π_{y}(j), π_{z}(j), or \vec{π}(j, t) between shots. This could be done, for example, directly via the portable unit 200, or by communication of the portable unit with some other system, such as laptop, tablet, or other computing system, controlled by the coach. This would allow a player to “experiment” with different paths to find the one most natural or comfortable, to try different motions, etc.

The invention need not be restricted to sensing of only single paths. Instead, depending on the sport, a player might wear more than one sensing unit 100, for example, one on each wrist, or one on each foot, or on the head and somewhere else, for comparison and deviation detection of actual motion paths with separate “goal” paths I* for each sensing unit.

In the embodiment used for primary illustration above, that is, in the context of golf, the reference frame (such as x-y-z) is fixed during the calibration procedure at setup and address. In some other sports, this may not be practical, or the best choice. For example, assume that an athlete wants to train the correct path for cross-country “skate skiing”. In this sport, both feet need to be able to move in a coordinated manner toward each other and diagonally apart, with a forward stepping motion, just as in ice, roller, or in-line skating, but of course with skis on. In this case, a correct path may be defined for each foot/ski separately, but still in relation to the position of the opposite foot/ski. Moreover, unless in some kind of static simulator, the skier will be moving forward. The invention may be adapted even to this situation.

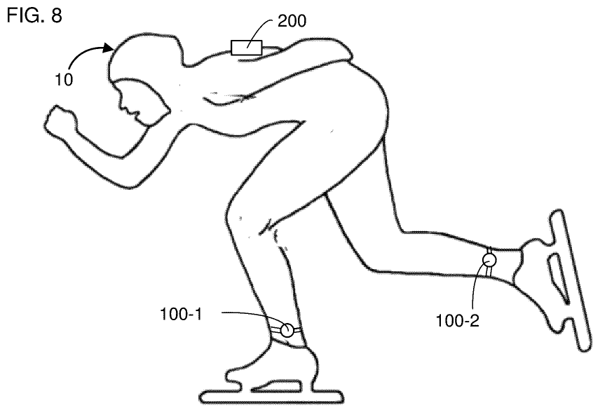

First, in such “relative motion” cases, one more that one sensing unit may be positioned on the player's body. One of the sensors may be configured or designated as the reference sensor unit such that, after calibration as above to determine an initial rest position for each of the other secondary sensor(s), its position in either Cartesian space or otherwise may be taken to be the origin of the coordinate system that the portable unit (such as component 232) uses to compute the sensed relative path for all sensor units. Then, even if one sensor is assumed always to be at an origin position \vec{p}_{REF}(i)=\vec{0}, the position \vec{p}_{REL}(j), that is, the sequence of relative position values, of the other, secondary sensor relative to \vec{p}_{REF}(i) may be computed using simple translational distance computations, such that an actual relative motion path for each sensor can also be determined and compared with respective stored, goal paths. For example, FIG. 8 depicts a player (here, speed skater) 10 with a reference sensor unit 100-1 on his left ankle and a secondary sensor unit 200-2 on his right ankle, with the portable device 200 positioned on his back (merely to illustrate the concept). Thus, this embodiment of the invention may be used to determine and signal the player of such “mistakes” as taking too big/small a stride (relative distance between feet too large/small), reaching too far or near (for hand-foot sensor combinations), having too great or too small a separation between the knees, hands, feet, etc. By including relative velocity/speed profiles, the system may be used to detect and signal a need to correct motions with respect to velocity/speed as well.

Note that devices configured with Bluetooth version 5 and later allow for multiple devices (such as multiple sensor units) to communicate over a common Bluetooth channel with a primary device (such as the portable unit); similar capabilities are available using other communications technologies as well.

In some sports, more than two sensing units may also be used with similar relative motion, and more than one relative motion could be accommodated. For example, one sensing unit could be placed on the wrist or hand of a rower, with another positioned on his knee, and still another on his hip, so as to be able to sense the paths of these relative to a reference sensing unit, for comparison and real-time signaling of deviation from (or adherence to) respective goal paths. The reference sensor could be placed, for example, on an ankle (which is typically stationary relative to the boat), or even on a fixed position on the boat itself, which would also allow the portable unit to determine a resting position of the boat itself before beginning a tracking session, and to sense and adjust out the motion of the boat. If not only position but also velocity and/or acceleration profiles are tracked and compared with goal profiles, and these are made function of and aligned with respect to time, then not only can the proper motion for each of the Catch, Drive, Finish and Recovery phases of a stroke be guided, but the timing of these motions can also be tracked and trained as well.

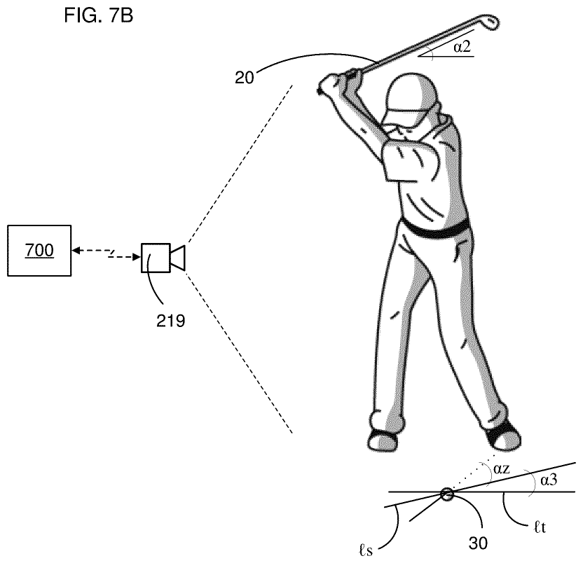

FIGS. 7A and 7B illustrate an arrangement that can be used together with the system described above, or independently, to obtain more information about a player's stroke for analysis. As the figures depict, either or both of a pair of cameras 218, 219 capable of capturing video are positioned such that they can image the player from the front (FIG. 7A) and the side to which the player swings the club 20 during the upswing (FIG. 7B). The cameras may be dedicated video recorders, or be incorporated into some other device, such as a smart phone with a high enough frame rate to be able to capture points sufficient to establish the path of the club head immediately after impact with the ball, as well as, preferably, at least two or three frames showing the position of the ball after impact so as to be able to establish its initial trajectory.

The recording function of the cameras 218, 219 may be started manually, for example, by the player or some other person, or could be configured to receive a signal from the device 200 when its tracking functions described above are initiated, either manually or automatically upon sensing the beginning of the stroke.

Various values relating to a stroke may be derived from imaging of the player as he swings. For example, the angles α1 and α2 may be determined at the top of the upswing (sensed as described above), indicating the angles the club 20 makes with the ground (the x-y plane, as depicted in the figures) in the y and x directions, respectively. The intended target line lt and the actual swing line is may also be detected, from which the angle α3 between the two may be determined, and the launch angle αz (relative to the ground plane) of the trajectory of the ball after being struck may also be determined, assuming that the frame rate of the camera 218 is high enough to capture at least one frame after the ball is struck.

Other values that may be determined by the system 700 include the divot point and club angle of attack, which is a function of the club face angle (its “loft”) itself. The divot point may be taken to be the point at which the club head is at its lowest in the z-direction. The angle of attack (not shown in the figures to avoid clutter) may be determined from the line of the club head one or more frames before contact with the ball up to the point of contact. As for the club loft, this may be an input parameter into the processing system, although it could also be derived by imaging as well, assuming proper training of the learning algorithm and assuming sufficient camera speed.

Once the various lines and angles have been identified and computed, they may be displayed (such as via the component 730 or an external system) for a user to view for analysis and training. The displayed image could, for example, overlay the lines and angles onto frames of the captured video.

These operations of course require more than just the camera(s) 218, 219, and to that end the camera(s) either communicate using any known technology with a processing system 700 for real-time or post-recording transfer, or the recordings from the camera(s) are otherwise transferred to the system 700 for processing and analysis. The processing system 700 preferably includes a software module/component 710 that is able to identify features of interest in the recorded images, a software module/component 720 that tracks the motions of the player as he swings to extract the values such as the various angles and lines described above; and a module/component 730 to present (such as on a viewable display) the results for viewing and analysis, for example by the player, a coach, or any other person. The software modules/components 710, 720, 730 may be implemented as a single body of code but are shown separately for clarity. In actual implementation, these components 710, 720, 730 will be embodied as processor-executable code that is stored in any conventional storage/memory components that are included in the system 700 and executed by one or more processors within the system, although the presentation component 730 may be or include hardware such as a conventional display.

One way to enable feature identification is by using a machine learning algorithm that is trained on images of players during strokes. In most embodiments, and in the context of golf, image features of interest will typically be the club 20 (which will appear substantially as a line segment), the ball 30, and possibly the club head. There may also be body-related features of interest. In the context of archery, for example, the location and orientation of the draw arm and in particular its elbow in relation to an anchor point such as the jaw and relative to the line of the arrow, will be of interest; other features may be of particular interest for analysis in other sports or activities. FIG. 7A depicts some of the body-related features that the processing system 700 could extract and determine, namely angles αg, αh, and αₖ, representing, respectively, the grip angle between the player's forearm and the club, and the angles of hip and knee bend.

One advantage of using machine learning to recognize selected features in images of players in action is that it does not require the player to wear any additional equipment. Another option would be to attach passive or active motion capture markers to relevant points of his body and equipment, such as on the knee, elbow, wrist, shoulder, etc. and then use known imaging techniques to sense the location of the markers, to generate a moving “stick figure”, from which the motion of particular points (wrist, hip, elbow, club head, etc.) can be determined.

Still another method would be for an observer (such as a coach) to manually select points to be tracked on an initial image of the player and equipment. Known imaging techniques may then be used to “follow” these points during a stroke.

Determining the location of a point over the course of several imaging frames of course will also determine the path of the point, from which the lines and angles shown in FIGS. 7A and 7B (or lines and angles of interest in other contexts) can also be determined. The target line lt, however, will typically be defined as a line passing through the ball 30 and parallel to the line with which the player's feet are aligned; this may also be determined automatically, or manually.

Once the paths of points are extracted in the component 720, known algebraic techniques may be applied to determine the various angles of interest. Moreover, since the frame rate will be known or at least knowable, if at least one position of the ball after being struck is determined, its velocity can also be computed using the simple expression Δposition/Δtime. This assumes linear motion, however, which is a reasonable assumption over the distance likely to be travelled during one or only a few imaging frames. By determining the angle αz and the velocity, plus known parameters relating to air resistance on specific balls, the processing system may also be able to estimate the likely distance the ball will travel. This can then be updated for future use in calculation by inputting the actual distance of the shot.

The various values of interest may then be presented for viewing and analysis (via the component 730) in any preferred manner, such as viewing on a smart phone display, or on laptop or other computer.

For some computations, it is necessary to be able to determine linear distance, which, in the given contexts, requires some reference. One possible reference may be derived from the imaging system itself; for example, if the distance from the camera to the ball (or player) is known (for example, simply by placing the camera at that distance), then linear distance can be computed using known methods given knowledge of the camera lens, aperture setting, etc.

In another embodiment, the data from the units 100, 200 may be combined with the data derived from imaging, either in the processing system 700, or in any other computing system capable of display to a user. For example, to improve accuracy in determining a divot point, the lowest point imaged could be synchronized with the point at which the component of acceleration in the z-direction reaches a minimum (zero or very close to zero) at the end of phase II (FIG. 3).

One of the drawbacks of the prior art that is mentioned in the Background section of this disclosure is that known sport trainers typically require some object such as a sensor to be mounted on the item of sports equipment (such as a golf club) whose motion is to be tracked. This at best still changes the mass properties of the equipment, such that it may not perform exactly as it would otherwise, or the user will not use it in exactly the same way. It may also be a distraction to the user, who will then also not perform as he would in actual play. As should now be clear from the drawings and the description above of the various embodiments of the invention, the invention overcomes this drawback—using any of the embodiments of the invention, the sports equipment may be used as is, without modification of its normal configuration, appearance, mass properties, or otherwise, since no sensors or others devices, markers, or other objects need to be attached to it in order to enable the invention to track motion in real time and, depending on the embodiment, provide real-time feedback to the user. Moreover, using the embodiments of the invention, there is no need for user to have to look up from his normal activity to get such real-time information. Furthermore, most of the described embodiments enable tracking of the motion of the sports equipment using devices such as a smart phone and/or sports watch that the user is likely to have available for other purposes as well; this too avoids a distraction in that it does not require the player to have any different “feel” when performing, for example, a golf swing.

1. A method for sports training comprising:
positioning at least one sensing unit on a body part of a player, said player using an item of sports equipment, which has mass properties, said sensing unit generating acceleration signals corresponding to sensed accelerations of the body part of the player, the sensing unit communicating with a portable unit positioned on the player, said item of sports equipment retaining its mass properties by remaining unencumbered by both the sensing unit and the portable unit;
converting the acceleration signals to positional values;
within the portable unit,
pre-determining and storing, within the portable unit, at least one intended position of the sensing unit;
as the player executes a motion with item of sports equipment, in real time, as the player executes the motion:
determining, from the positional values, at least one actual position of an actual path of the sensing unit;
comparing the at least one actual position with corresponding respective one(s) of the least one intended position; and
generating for the player a perceptible signal indicating a measure of correspondence between the actual path and the at least one intended position, whereby the player receives the perceptible signal in real time and without the item of sports equipment having to be altered from its normal configuration and mass properties and without the player having to alter the player's normal use of the sports equipment in order to receive the generated perceptible signal.

2. The method of claim 1, in which the player is a golfer and the motion is the swing of a golf club.

3. The method of claim 2, further comprising positioning the sensing unit on a wrist of the player and computing a position of a head of the golf club as a function of an input length of the club and the position of the sensing unit.

4. The method of claim 2, in which:
the at least one intended position is a top-of-swing position; and
the measure of correspondence is that the distance between an actual, sensed top-of-swing position and the intended position is less than a pre-determined threshold value.

5. The method of claim 3, further comprising:
sensing an indication of a beginning of the swing; and
automatically determining a measure of overshifting of the player by comparing horizontal and vertical acceleration components of the sensing unit immediately after sensing the indication of a beginning of the swing;
in which the measure of correspondence is a function of the measure of overshifting.

6. The method of claim 1, comprising:
within the portable unit, storing a series of the at least one intended position to form a multi-positional, intended path;
sensing a series of the actual positions of the sensing unit to form a representation of the actual path; and
computing the measure of correspondence as a metric of closeness of correspondence between the intended path and the actual path.

7. The method according to claim 6, further comprising, within the portable unit, computing from the acceleration signals an actual velocity profile of the sensing unit during the motion and generating the signal if the actual velocity profile, as the player executes a motion, deviates by more than a predetermined intended velocity profile.

8. The method of claim 1, further comprising presenting sensed and computed motion data for viewing and analysis by a user.

9. The method of claim 2, in which the motion is a swing by the player of a golf club, further comprising computing, within the portable unit, an estimated distance that a golf ball will travel based on the sensed acceleration signals and inputted club parameters, including club length and loft.

10. The method of claim 9, further comprising inputting into the portable unit environmental factors, and adjusting the estimated distance according to the environmental factors, the environmental factors being chosen from a group including wind speed, wind direction, air temperature, and course altitude.

11. The method of claim 1, comprising integrating the sensing unit and portable unit in a single device.

12. The method of claim 1, in which the sensing unit is chosen from a group including a smart watch, sports watch, and activity tracker, and the portable unit is a mobile phone.

13. The method of claim 1, further comprising:
positioning a plurality of the sensing units on the player;
designating a chosen one of the sensing units to be a reference unit, the remaining sensing units being secondary sensing units;
in the portable unit:
sensing a respective sequences of the acceleration signals from each of the plurality of sensing units; and
computing relative positional information between the reference unit and each of the secondary sensing units;
in which the intended position of each of the secondary sensing units is defined relative to the reference sensor unit.

14. The method of claim 2, in which the player is a golfer, further comprising:
capturing at least one video image of the player during the motion;
extracting image features from the captured video image(s), including a golf club held by the player;
determining from the captured video image(s) a target line and an actual swing line for a head of the club upon impact with the ball and computing an angular difference between the target line and the actual swing line; and
presenting for viewing by a user a representation of the target line and the actual swing line.

15. A method according to claim 1, in which the perceptible signal is audible.

16. A method according to claim 1, in which the perceptible signal is haptic.

17. A method according to claim 1, further comprising generating the perceptible signal via the sensing unit.

18. A method according to claim 1, further comprising generating the perceptible signal via the portable unit.
